(19) United States
(12) Patent Application Publication
(10) Pub. No.: US 2018/0235018 A1
(43) Pub. Date: Aug. 16, 2018

(54) USER EQUIPMENT(UE) DEVICE-ASSOCIATED IDENTIFIERS

(71) Applicants: David COMSTOCK, San Diego, CA (US); Kyocera Corporation, Kyoto (JP)

(72) Inventor: David COMSTOCK, San Diego, CA (US)

(21) Appl. No.: 15/751,085

(22) PCT Filed: Aug. 11, 2016
(86) PCT No.: PCT/US2016/046477

§ 371 Date: Feb. 7, 2018

Related U.S. Application Data
(60) Provisional application No. 62/203,776, filed on Aug. 11, 2015.

(51) Int. Cl. H04W 76/11; H04W 92/20; H04W 36/08

(52) U.S. Cl. CPC H04W 76/11; H04W 8/26; H04W 36/08; H04W 92/20

(57) ABSTRACT

User equipment (UE) devices are identified at a network node by a UE identifier from a UE identifier list and list identification information. A plurality of identical user equipment (UE) identifier lists are maintained at the network node where each UE identifier list is associated with a set of functions. Where a message transmitted from a first network node to a second network node is uniquely associated with a set of functions associated with a UE identifier list, the list identification information is the type of message. Where a message transmitted from a first network node to a second network node is not uniquely associated with a set of functions that pertains to a UE identifier list, the list identification information is a parameter in the message where the parameter is indicative of a UE identifier list.

### CLAIM OF PRIORITY

The present application claims priority to Provisional Application No. 62/203,776 entitled “METHODS FOR ASSIGNING AND RESOLVING UE IDENTIFIERS FOR INTERNODE SIGNALING,” filed Aug. 11, 2015, assigned to the assignee hereof and hereby expressly incorporated by reference in its entirety.

### FIELD

This invention generally relates to wireless communications and more particularly to user equipment (UE) device identifiers.

### BACKGROUND

Communication systems that provide wireless service to user equipment (UE) devices often include network nodes that must assign unique identifiers associated with UE devices. Messages are exchanged between the network nodes within the communication system such that each network node associated with service to a UE device uniquely identifies the UE device associated with a message. Some conventional systems include UE identifier (ID) lists where UE IDs are selected from the list to identify UE devices and the UE IDs are conveyed to other network nodes such that network nodes use UE IDs to uniquely identify UE devices that are being served by a network node.

### SUMMARY

User equipment (UE) devices are identified at a network node by a UE identifier from a UE identifier list and by list identification information. A plurality of identical user equipment (UE) identifier lists are maintained at the network node where each UE identifier list is associated with a set of functions. Where a message transmitted from a first network node to a second network node is uniquely associated with a set of functions associated with a UE identifier list, the list identification information is the type of message. Where a message transmitted from a first network node to a second network node is not uniquely associated with a set of functions that pertains to a UE identifier list, the list identification information is a parameter in the message where the parameter is indicative of a UE identifier list.

### BRIEF DESCRIPTION OF THE DRAWINGS

FIG. 1A is a block diagram of an example of a network node in a communication system.

FIG. 1B is a block diagram of an example of a communication system using multiple UE ID lists at a network node.

FIG. 2 is a message diagram of transmissions and events for an example where the eNBs assign and manage UE IDs for a handover of the first UE device from the first eNB to the second eNB.

FIG. 3 is a message diagram of transmissions and events for an example where the eNBs assign and manage UE IDs for a SeNB addition procedure adding the second eNB as a SeNB for the second UE device.

FIG. 4 is block diagram of an example of a message that includes a UE ID and UE ID list identification information.

FIG. 5 is a flow chart of an example of a procedure performed at a network node for managing UE IDs where the node includes at least two UE ID lists.

FIG. 6 is a flow chart of an example of a procedure performed at a network node for managing UE IDs where the network node forms a logical connection with a second network node that includes at least two UE ID lists.

### DETAILED DESCRIPTION

As mentioned above, UE identifiers are used to identify associated UE devices in inter-node signaling messages. In mobile telecommunications networks, such as those based on The Third Generation Partnership Project (3GPP) Long Term Evolution (LTE) specifications, for example, signaling messages exchanged between network nodes often contain information that relates to a specific UE device. These UE-associated messages include a parameter that identifies the associated UE device uniquely within the network node receiving the message. In LTE networks, peer network nodes exchange the UE identifiers that have been assigned to a particular UE device when the connection for that UE device is set up between the network nodes. This pair of UE identifiers defines a bidirectional logical connection between the two network nodes that is associated with the UE device, and a single UE identifier assigned by a network node uniquely identifies this logical connection within that network node. Communication specifications often limit the number of UE identifiers to a maximum specified number. For example, this limitation may be due to the number of bits allocated to the UE identifier. System implementations coupled with new requirements of the communication specifications however, may result in a need for more than the maximum number of UE identifiers.

In at least some revisions of the 3GPP LTE communication specification, for example, control protocol signaling messages are specified for the X2 reference point for functions of an eNB logical network node that interact with functions of another eNB logical network node. The X2 Application Protocol (X2AP) defines the signaling messages for the X2 reference point. For UE-associated messages, the eNB UE X2 AP ID (eNB X2ID) parameter is used to identify a UE device within the network node receiving a message. A bidirectional logical connection associated with a UE device can be established between two logical eNBs and is represented by a pair of eNB X2IDs and has context information associated with it. LTE specifications, however, require that an eNB X2ID uniquely identifies a UE device within a logical eNB for such a logical connection rather than identifying a UE device using the pair of eNB X2IDs. This requires more eNB X2ID values than would be otherwise be needed. In accordance with communication specifications, a different eNB X2ID for a UE device must be used for each logical connection with a logical eNB instead of using the same eNB X2ID for a UE device for all logical connections and differentiating logical connections using the eNB X2ID of the logical eNB at the opposite endpoint of the logical connection.

In some system implementations, a physical network node may perform more than one function. If the physical network node is considered to be a single logical network node by a communication specification, the network node may need to uniquely identify each UE device for all functions handled at the physical network node. As a result, there may be a need for more than the maximum specified number of UE identifiers.

An example of a multiple function network node in an LTE system includes a eNB that supports Single Connectivity (SC) eNB functions and Dual Connectivity (DC) functions. Dual Connectivity (DC) is a feature in the LTE specifications that allows a UE device to be connected to two eNBs at the same time and to exchange data simultaneously with both eNBs. For Dual Connectivity, two functional entities are specified, the Master eNB (MeNB) and the Secondary eNB (SeNB). A MeNB may use the radio resources of a SeNB to enhance the service that it provides to the UE devices it is serving. A MeNB can offload some of its UE devices' data to be handled by a SeNB, although these UE devices are being served by the MeNB. The MeNB performs all the radio interface signaling for the UE devices' operating with DC and provides the SeNB with information about the UE device. The SeNB provides to the MeNB the radio configuration for its radio resources to be used by a DC UE device and the MeNB sends this to the UE device. The UE device then establishes radio connection with the SeNB while maintaining a radio connection with the MeNB.

DC messages have been defined in the LTE specifications that are exchanged between the MeNB and the SeNB, and eNB X2AP IDs are used to identify a UE in these signaling messages.

A logical eNB network node that includes both Single Connectivity (SC) eNB functions and SeNB functions will serve additional UEs than it would otherwise, because the SeNB functions provide radio service to UEs being served by the MeNB. In addition, the eNB X2IDs used for the SeNB functions will be in use as long as it serves as an SeNB, which is generally longer than other functions using eNB X2IDs. If both SC eNB functions and SeNB functions are considered to be part of the same a logical eNB, then the eNB X2IDs used for both functions should uniquely identify a UE within the logical eNB, and so they will be assigned from the same eNB X2ID list, which increases the risk that there may be an insufficient number of values.

In LTE systems, therefore, there is a need for methods for assigning eNB X2IDs for DC operation that reduces the risk that there may be an insufficient number of values but allows a single UE device to be uniquely identified for a logical connection. Generally, there is a need for methods of assigning and managing UE Application Protocol IDs especially where the number of UE AP IDs is limited to a maximum number at a network node.

The examples discussed herein facilitate identifying UE devices using multiple UE ID lists at a network node. UE devices are identified at a network node by a UE identifier from a UE identifier list and list identification information. A plurality of identical user equipment (UE) identifier lists are maintained at the network node where each UE identifier list is associated with a set of functions. For example, a first UE identifier list may be associated with messages pertaining to a set of SeNB functions and a second UE identifier list may be associated with messages pertaining to a set of SC eNB functions. Where a message transmitted from a first network node to a second network node is of a type that is uniquely associated with a set of functions associated with a UE identifier list, the list identification information is the type of message. For example, where a message that is uniquely associated with an SeNB function is received by a network node functioning as an SeNB, the relevant UE ID list is identified as the one associated with SeNB functions. Where a message transmitted from a first network node to a second network node is not of a type that is uniquely associated with a set of functions that pertains to a UE identifier list, the list identification information is a parameter in the message such that the parameter is indicative of a UE identifier list. For example, where a message that is associated with more than one function is received by a network node functioning as an SeNB, the relevant UE ID list is identified with a parameter included in the message.

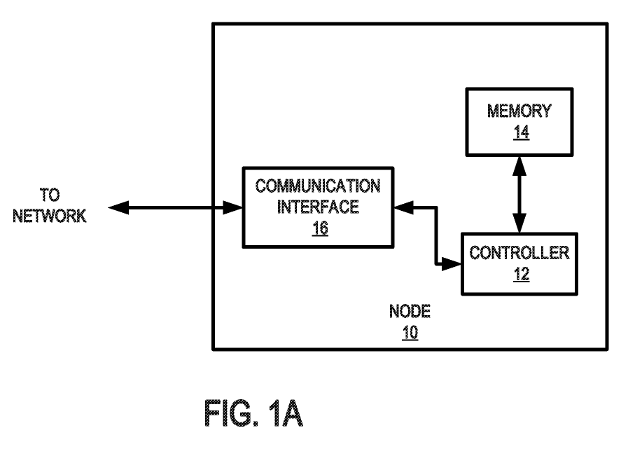

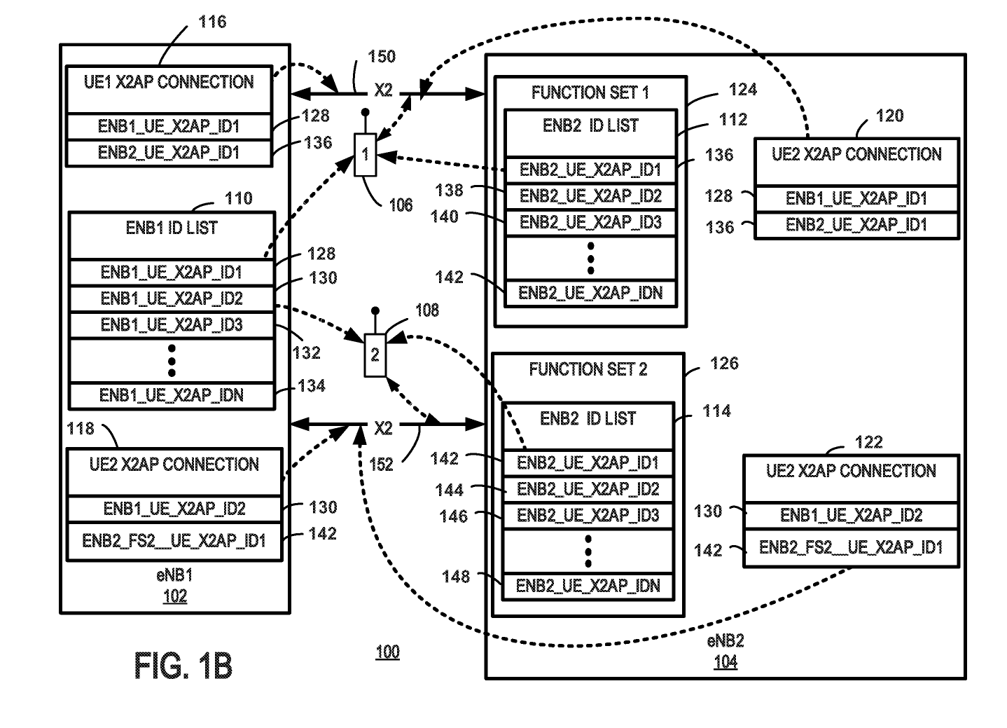

FIG. 1A is a block diagram of an example of a network node 10. The network node 10 may be any switching point or database in the network. Examples of network nodes include base station controllers, Home Location Registers, Gateway GPRS Support Nodes (GGSNs) and Serving GPRS Support Nodes (SGSNs), For the examples herein, the network node may be an enhanced Node B (eNB). The network node 10 includes at least electronics such as controller 12, memory 14 and communication interface 16 for communicating through the network with other network nodes. The controller 12 may be any processor, processor arrangement, or other electronics that can execute code to perform the functions described herein as well as facilitating the overall operation of the network node 10. The memory 14 is any memory device suitable for storing information discussed with reference to the UE ID assignment and management discussed herein as well as information for facilitating the overall operation of the network node. The communication interface 16 is electronics suitable for communicating through the network with other network nodes. For example, the communication interface 16 may support network communications and protocol for exchanging data and control information with other network nodes over an X2 connection. Depending on the type of network node 10, the network node 10 may include other components devices, equipment and/or functionality. For example, where the network node 10 is an eNB, the eNB typically includes electronics and components for providing wireless service such as radio transceivers and antennas for wirelessly communicating with user equipment (UE) devices.

FIG. 1B is a block diagram of an example of a communication system 100 using multiple UE ID lists at a network node. For the example of FIG. 1B, the operation of the system 100 is based on at least one revision of the 3GPP LTE communication specification. The techniques and principles discussed with reference to FIG. 1B, however, may be applied to other types of systems.

FIG. 1B shows two network nodes 102, 104 and two UE devices 106, 108. For the example of FIG. 1B, the network nodes are eNBs where a first eNB (eNB1) 102 and a second eNB (eNB2) 104 provide wireless communication service to a first UE device (UE1) 106 and a second UE device (UE2) 108. The eNBs 102, 104 are sometimes referred to as enhanced Node Bs, eNodeBs and base stations and include electronics for transmitting and receiving wireless signals to serve UE devices. Each eNB 102, 104 includes hardware and code including memory for managing communications with the UE devices as well as between the eNBs and other network nodes. As part of the management, the eNBs maintain UE ID lists 110, 112, 114 which are used to identify UE devices and logical connections. As discussed below, UE IDs from the UE ID lists 110, 112, 114 are used to create and identify logical connection records 116, 118 120, 122 that identify logical connections in the network 100. The UE ID lists 110, 112, 114 and the logical connection records 116, 118, 120, 122 are represented as blocks in FIG. 1B.

For the example, the first eNB 102 includes a single UE ID list 110 and the second eNB 104 includes two UE ID lists 112, 114 where each list is associated with a function set. Accordingly, the second eNB 104 includes a first UE ID list 112 associated with a first function set 124 and a second UE ID list 114 associated with a second function set 126. Each function set 124, 126 is a set of functions uniquely associated with at least one particular service or mode of operation. A function set 124, 126 may include a unique set of messages that are sent or received to facilitate the particular service or mode. As discussed below, for example, the second eNB 104 may support SC eNB functions and SeNB functions and the first UE ID list 112 is associated with the unique set of functions for providing SC eNB and the second UE ID list 114 may be associated with the unique set of functions for providing SeNB. For the example, the first eNB UE ID list 112 is identical to the second UE ID list 114, which are also identical to the eNB UE ID list 110 in the first eNB 102. The second eNB 104 uses the first eNB UE list 112 to identify UE devices that are being served under the first function (e.g. SC eNB) and uses the second UE ID list 114 to identify the UE devices under the second function (e.g., SeNB). The UE ID list 110 at the first eNB 102 includes a plurality of UE IDs 128, 130, 132, 134 from a first UE ID (UE ID 1) 128 to an Nth UE IE (UE ID N) 134. Similarly, UE ID lists 112, 114 at the second eNB 104 include a plurality of UE IDs for each function set. Accordingly, the first UE ID list 112 at the second eNB 104 includes a plurality of UE IDs 136, 138, 140, 141 associated with the first function set 124 from a first UE ID (UE ID 1) 136 to an Nth UE IE (UE ID N) 141 and the second UE ID list 114 at the second eNB 104 includes a plurality of UE IDs 142, 144, 146, 148, associated with the second function set 126 from a first UE ID (UE ID 1) 142 to an Nth UE IE (UE ID N) 148. As noted above, the two lists are identical for the example. As a result, the values of the first UE IDs 136, 142 are the same, the values of the second UE IDs 138, 144 are the same and so on.

In the example, the first eNB 102 includes a single UE ID list 110. For the such an example, the first eNB 102 does not provide service under more than one mode or function. For example, in a situation where an eNB is functioning as an SC eNB and a DC MeNB, the number of UE devices it is serving does not change, so the number of UE IDs provided in the specification should be sufficient. The first eNB 102, therefore, assigns UE IDs from the one UE ID list to all of the UE devices that it serves. For the example, the first eNB 102 assigns a first UE ID (eNB1_UE_X2AP_ID1) 128 to the first UE device 106 for a logical connection with the second eNB 104 associated with UE device 106 and assigns a second UE ID (eNB1_UE_X2AP_ID2) 130 to the second UE device 108 for a logical connection with the second eNB 104 associated with UE device 108.

In the example, the first UE device 106 is assigned a UE ID by the second eNB 104 under a first function set 124 for a logical connection with the first eNB 102 associated with UE device 106. This set 124 of functions may be for a function under SC eNB operation of the eNB such as a handover, for example. The second UE device 108 is assigned a UE ID by the second eNB 104 under a second function set 126 for a logical connection with the first eNB 102 associated with UE device 108. This set of functions may be for a function under SeNB operation of the eNB, for example. The second eNB 104 assigns the first UE ID (ENB2_UE-X2AP_ID1) 136 from the first UE ID list 112 associated with the first function set 124 to the first UE device 106 and assigns a first UE ID (ENB2_UE-X2AP_ID1) 142 from the second UE ID list 112 associated with the second function set 126.

During the execution of the procedure associated with the first UE device, the first eNB 102 and the second eNB 104 establish a logical connection and maintain a logical connection record 116, 120 that uniquely identifies the logical connection 150 between the two network nodes 102, 104 associated with the first UE device. The logical connection records 116, 120 include the UE IDs 128, 136 assigned by the eNBs 102, 104 and exchanged in messages, each eNB establishes a logical connection record 116, 120. The logical connection records 116, 120, which include identical UE ID values, are created and stored at each eNB 102, 104. For the example, the logical connection record 116, 120 includes the first UE ID 128 from the UE ID list 110 and the UE ID 136 from the UE ID list 112. Accordingly, each eNB assigns a UE ID such that the pair of UE IDs identifies the bidirectional logical connection. In other words, each UE ID uniquely identifies one end of the connection. Within a network node the single UE ID assigned by that network node uniquely identifies the logical connection associated with a particular UE and a particular peer network node.

The logical connection record 118, 122 for identifying the logical connection 152 associated with the second UE device 108 is established using the second UE ID (ENB1_UE_X2AP_ID2) 130 of the UE ID list 110 at the first eNB 102 and the first UE ID (ENB2_UE_X2AP_ID1) 142 of the UE ID list 114 associated with the second function set 126 at the second eNB 104. Since the second UE ID list 114 is identical to the first UE ID list 112, the eNB 104 uniquely identifies the UE device 108 by the UE ID and list identification information. Where the messages exchanged between the eNBs are associated with a particular function that, in turn, is associated with a UE ID list, the messages provide the list identification information based on the type of message, which is usually indicated in a parameter of the message. In situations where the message types themselves do not uniquely identify a function set, additional information is included in the message to identify the particular UE ID list. For example, a parameter can be included in the messages between the eNBs to identify the message as belonging to a particular function set, thereby associating the UE device with the UE ID list associated with the function set.

Therefore, a network node, such as eNB, uniquely identifies a UE device for a logical connection based on a UE ID from a UE ID list and list identification information. In some situations, the list identification information is associated with a function set. The UE ID values can, therefore, be associated with multiple function sets allowing the UE ID values to be reused for each function set. Numerous types of function sets can be identified. As mentioned above, one function set can be associated with an eNB's service as a SC eNB and another function set can be associated with the eNB's service as a SeNB.

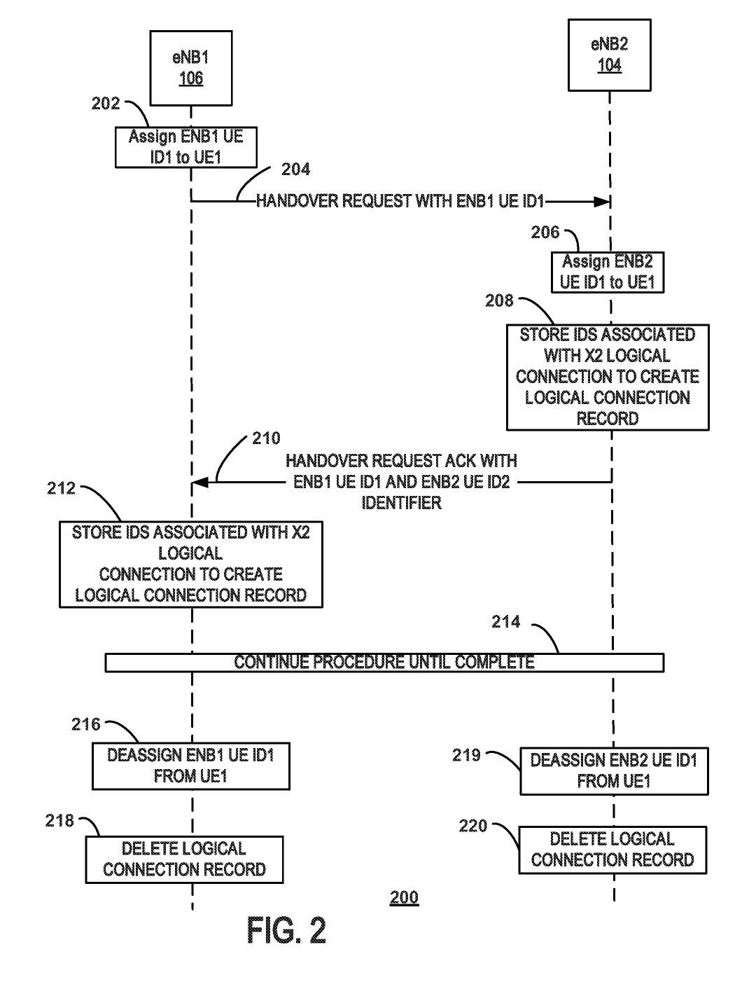

FIG. 2 is a message diagram 200 of transmissions and events for an example where the eNBs 102, 104 assign and manage UE IDs for a handover of the first UE device 106 from the first eNB 102 to the second eNB 104. The procedure discussed with reference to FIG. 2, therefore, is an example where the second eNB 104 is operating as a SC eNB.

At event 202, the first eNB 102 assigns the first UE ID (ENB1_UE_X2AP_ID1) 128 to the first UE device 106. For the example, the first eNB 102 assigns a UE ID from its UE ID list 110 in accordance with at least one revision of the 3GPP LTE standard.

At transmission 204, the first eNB 102 sends a Handover Request Message that includes the first UE ID 128. The message 204 typically is sent in accordance with the communication specification. For the example, the message is sent in accordance with at least one revision of the 3GPP LTE communication specification.

After receiving the Handover Request message, the second eNB 104 assigns a UE ID to the first UE device 106 at event 206. The second eNB 104, for example, assigns the first UE ID (ENB2_UE_X2AP_ID1) 136 from the UE ID list 112 associated with the function set 124 associated to the operation of the eNB as a SC eNB.

At event 208, the second eNB 104 creates and stores a logical connection record that corresponds to the X2 logical connection 150 for the handover procedure. Accordingly, the UE ID 128 assigned by the first eNB 102 and the UE ID 136 assigned by the second eNB 104 are used to create the logical connection record 120.

At transmission, 210, the second eNB 104 sends a Handover Request Acknowledgment message to the first eNB 102 where the message includes the UE IDs 128, 136. The message 210 is transmitted in accordance with the communication specification and received at the first eNB 102.

At event 212, the first eNB 102 creates and stores a logical connection record 116 that corresponds to the X2 logical connection 150 for the handover procedure. Accordingly, the UE ID 128 assigned by the first eNB 102 and the UE ID 136 assigned by the second eNB 104 are used to create the logical connection record 116.

At event 214, the handover procedure continues until completion. The second eNB 104 identifies the UE ID list 112 for UE ID 136 that is received in a message by correlating the message type to a function set. This is necessary because UE ID 136 from UE ID list 112 has the same value as UE ID 142 from UE ID list 114. In the example, handover is a SC eNB function, which correlates to function set 124 and the second eNB can associate UE ID 136 with UE device 106.

At event 216, the first eNB 102 deassigns the first UE ID 128 associated with the first UE device 106 releasing the first UE ID 128 to be associated to a UE device when appropriate. Since the handover of the first UE device 106 to second eNB 104 has been completed, this logical connection is no longer needed.

At event 218, the first eNB 102 deletes the logical connection record 116 for the X2 connection 150.

At event 219, the second eNB 104 deassigns the first UE ID 136 associated with the first UE device 106 releasing the first UE ID 136 to be associated to a UE device when appropriate. Since the handover of the first UE device 106 to the second eNB 104 has been completed, this logical connection is no longer needed.

At event 220, the second eNB 104 deletes the logical connection record 120 for the X2 connection 150.

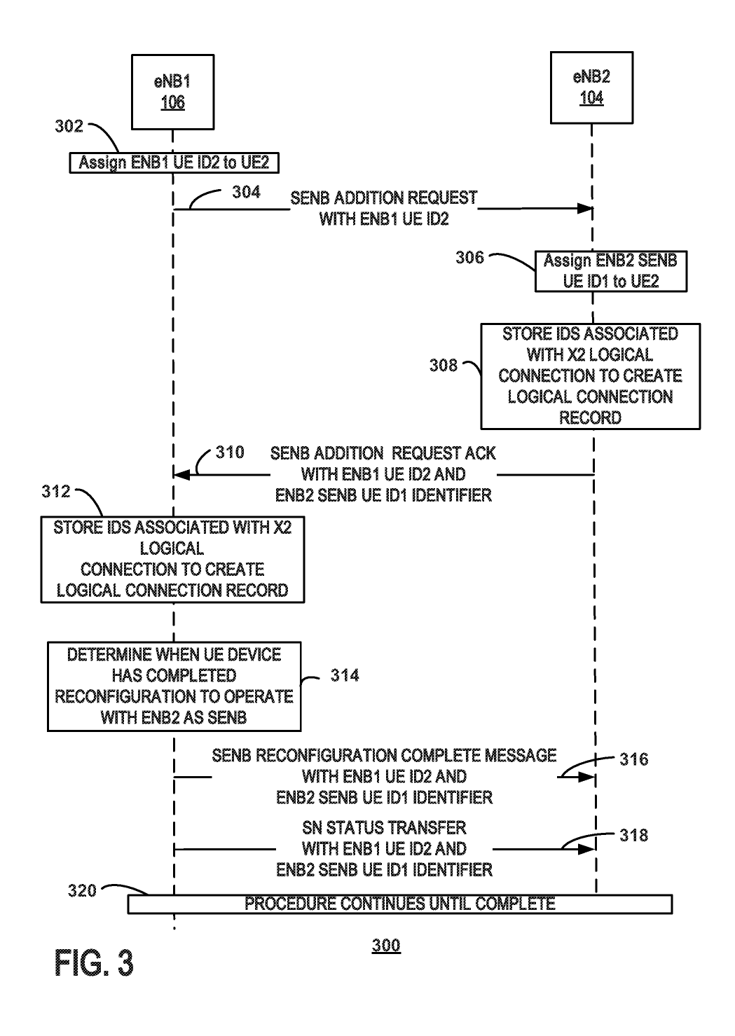

FIG. 3 is a message diagram 300 of transmissions and events for an example where the eNBs 102, 104 assign and manage UE IDs for a SeNB addition procedure adding the second eNB 104 as a SeNB for the second UE device 108. The procedure discussed with reference to FIG. 3, therefore, is an example where the second eNB 104 is operating as a SeNB. The procedure of FIG. 3 may be in conjunction with the procedure of FIG. 2. For example, the first UE device 106 may be transferred to the second eNB 104 in a handover where the second eNB operates as a SC eNB and the second eNB 104 may be added as a SeNB for the second UE device 108 where the second eNB operates as a SeNB. Therefore, discussion with reference to FIG. 2 and FIG. 3 provides an example of procedures where UE IDs are assigned and managed for the example of UE ID assignment and management discussed with reference to FIG. 1B.

At event 302, the first eNB assigns the second UE ID (ENB1_UE_X2AP_ID2) 130 to the second UE device 108. For the example, the first eNB 102 assigns a UE ID from its UE ID list 110 in accordance with at least one revision of the 3GPP LTE standard. For example, where the FIG. 2 and FIG. 3 are part of the same example, the second UE ID 130 may be assigned near, or at the same time as a UE ID is assigned to the first UE device in FIG. 2.

At transmission 304, the first eNB 102 sends a SeNB Addition Request Message that includes the second UE ID 130. The message 304 typically is sent in accordance with the communication specification. For the example, the message is sent in accordance with at least one revision of the 3GPP LTE communication specification.

After receiving the SeNB Addition Request message, the second eNB 104 assigns a UE ID to the second UE device 108 at event 306. The second eNB 104, for example, assigns the first UE ID (eNB2_SENB_UE_X2AP_ID1) 142 from the UE ID list 114 associated with the function set 126 associated with the operation of the second eNB 104 as a SeNB.

At event 308, the second eNB 104 creates and stores a logical connection record 122 that corresponds to the X2 logical connection 152 for the SeNB Addition procedure. Accordingly, the UE ID 130 assigned by the first eNB 102 and the UE ID 142 assigned by the second eNB 104 are used to create the logical connection record 122.

At transmission 310, the second eNB 104 sends a SeNB Addition Request Acknowledgment message to the first eNB 102 where the message includes the UE IDs 130, 142. The message 310 is transmitted in accordance with the communication specification and received at the first eNB 102.

At event 312, the first eNB 102 creates and stores a logical connection record 118 that corresponds to the X2 logical connection 152 for the SeNB Addition procedure. Accordingly, the UE ID 130 assigned by the first eNB 102 and the UE ID 142 assigned by the second eNB 104 are used to create the logical connection record 118.

At event 314, the first eNB 102 determines when the UE device 108 has completed its reconfiguration to operate with the second eNB 104 as a SeNB.

In response to determining that UE device 108 has completed its reconfiguration, the first eNB 102 sends a SeNB Reconfiguration Complete Message that includes the UE IDs 130, 142 at transmission 316. The second eNB 104 identifies the UE ID list 114 for UE ID 142 by correlating the message type to a function set. This is necessary because UE ID 136 from UE ID list 112 has the same value as UE ID 142 from UE ID list 114. In the example, SeNB Addition is a SeNB function, which correlates to function set 126 and the second eNB can associate UE ID 142 with UE device 108.

At transmission 318, the first eNB 102 sends a SN Status Transfer Message which is part of the SeNB Addition procedure according to the 3GPP LTE communication specification. The SN Status Transfer Message includes UE IDs 130, 142 and a parameter for UE ID list identification. The first eNB 102 knows that the SN Status Transfer Message is not uniquely associated with SeNB functions so it includes the UE ID list identification information as a parameter in the SN Status Transfer Message that indicates that the message is associated with SeNB functions. The second eNB correlates the UE ID list identification information to function set 126 and UE ID list 114 in order to associate UE ID 142 to UE device 108.

At event 320, the SeNB Addition procedure continues until completion in accordance with at least one revision of the 3GPP LTE communication specification.

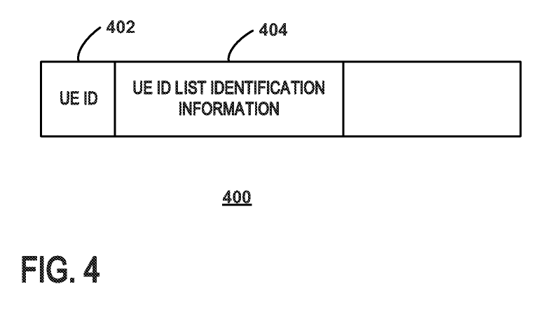

FIG. 4 is block diagram of an example of a message 400 that includes a UE ID 402 and UE ID list identification information 404. As discussed above, a network node in the network can use the same UE ID values in different UE ID lists for different function sets allowing the network node to uniquely identify a greater number of UE devices than allowed by a single UE ID list limited by a maximum number of IDs. In order to manage the IDs between other function sets and other network nodes, information in addition to the UE ID must be provided in messages concerning the UE devices that are identified. As discussed above for the examples of FIG. 2 and FIG. 3, the additional information may be derived from the type of message that is being received. Accordingly, a particular message may be uniquely associated with a function set and, in turn, with a UE ID list. Therefore, the UE ID identification information 404 may be the information in the message identifying the type of message and a new message parameter is not required. In some situations, the message may not be of type that uniquely associates the message with a function set and a UE ID list. In such situations, other additional information can be provided in the message to further identify the UE device. In one example, a UE ID list identifier parameter is included in the message. The parameter uniquely identifies a function set and/or a UE ID list. The parameter is included in all such messages between network nodes regarding the UE device that is to be identified in the message.

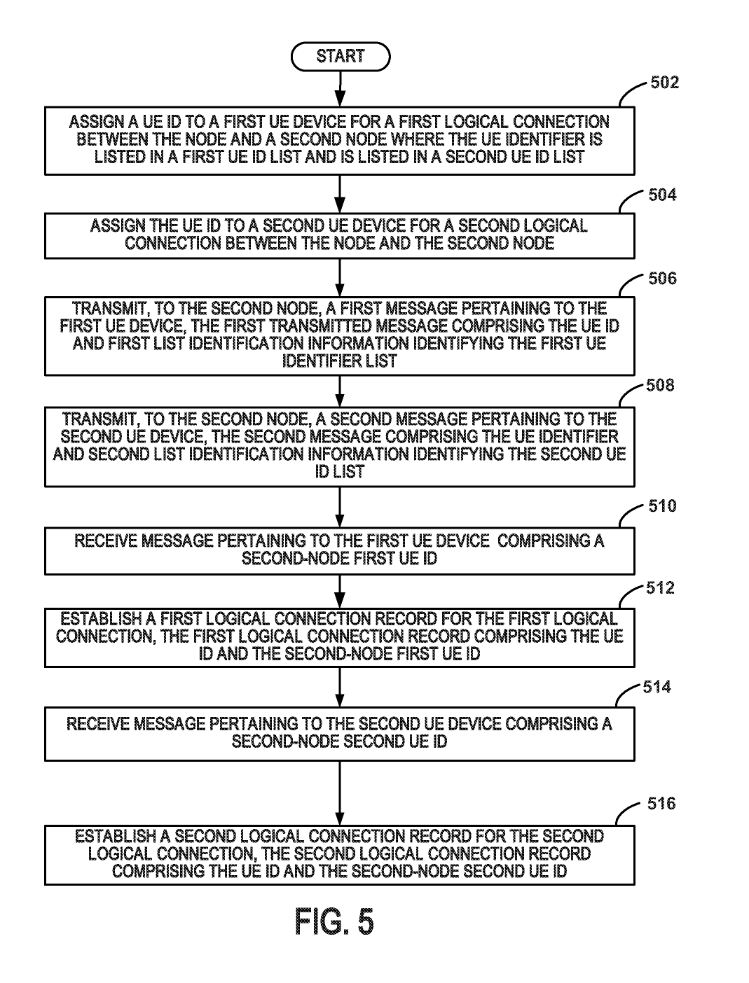

FIG. 5 is a flow chart of an example of a procedure performed at a node for managing UE IDs where the node includes at least two UE ID lists. The steps in the example may be performed in a different order than shown in FIG. 5. Although the example may be performed at any node in a network, an example of suitable node includes the eNB 104 discussed with reference to FIG. 1B. For the example below, however, the node where the procedure is performed is referred to as the first node and the node with which logical connections are formed is referred to as the second node.

At step 502, the first node in a network assigns a UE ID to a first UE device for a first logical connection between the first node and a second node where the UE ID is listed in a first UE ID list and in a second UE ID list. The first UE ID list and the second UE ID list include at least some of the same UE ID values. For the example, however, the UE ID list values are identical. Although the same UE ID value appears in both UE ID lists, the UE ID from the first list is assigned to the first UE device.

At step 504, the node assigns the same UE ID value to a second UE device for a second logical connection between the first node and the second node. The UE ID for the second UE ID is selected from the second UE ID list.

At step 506, a message pertaining to the first UE device is transmitted to the second node where the message includes the UE ID and first list identification information that identifies the first UE ID list.

At step 508, a message pertaining to the second UE device is transmitted to the second node where the message includes the UE ID and second list identification information identifies the second UE ID list. As discussed above, the list identification information may be the type of message that is being transmitted or may be a parameter within the message. The UE ID lists are each associated with a function set. Accordingly, the first UE ID list is associated with a first function set and the second UE ID list is associated with a second function set.

At step 510, a message pertaining to the first UE device is received from the second node where the message includes a second-node first UE ID, the first node first UE ID, and first node UE ID list identification information. Where the second node manages more than one UE ID list, the message also includes second node list identification information. Accordingly, the message includes a UE ID assigned by the second node. As mentioned above, the steps in the procedure may be performed in a different order. In some situations, for example, a message with the second-node UE ID may be received before the first node assigns the UE ID. Such as situation may occur where the second node initiates the logical connection for the UE device

At step 512, a first logical connection record for the first logical connection between the first node and the second node for the first UE device is established. The first logical connection record includes information related to the first UE ID assigned by the first node from the first UE ID list and the second-node first UE ID. Where the second node manages more than one UE ID list, the logical connection record also includes second node first list identification information.

At step 514, a message pertaining to the second UE device is received from the second node where the message includes a second-node second UE ID, first node first UE ID, and first node UE ID list identification information. Where the second node manages more than one UE ID list, the message also includes second node list identification information. Accordingly, the message includes a second UE ID assigned by the second node. As mentioned above, the steps in the procedure may be performed in a different order. In some situations, for example, a message with the second-node UE ID may be received before the first node assigns the UE ID. Such as situation may occur where the second node initiates the logical connection for the UE device.

At step 516, a second logical connection record for the second logical connection between the first node and the second node for the second UE device is established. The second logical connection record includes information related to the second UE ID assigned by the first node from the second UE ID list and the second-node second UE ID. Where the second node manages more than one UE ID list, the logical connection record also includes second node list identification information

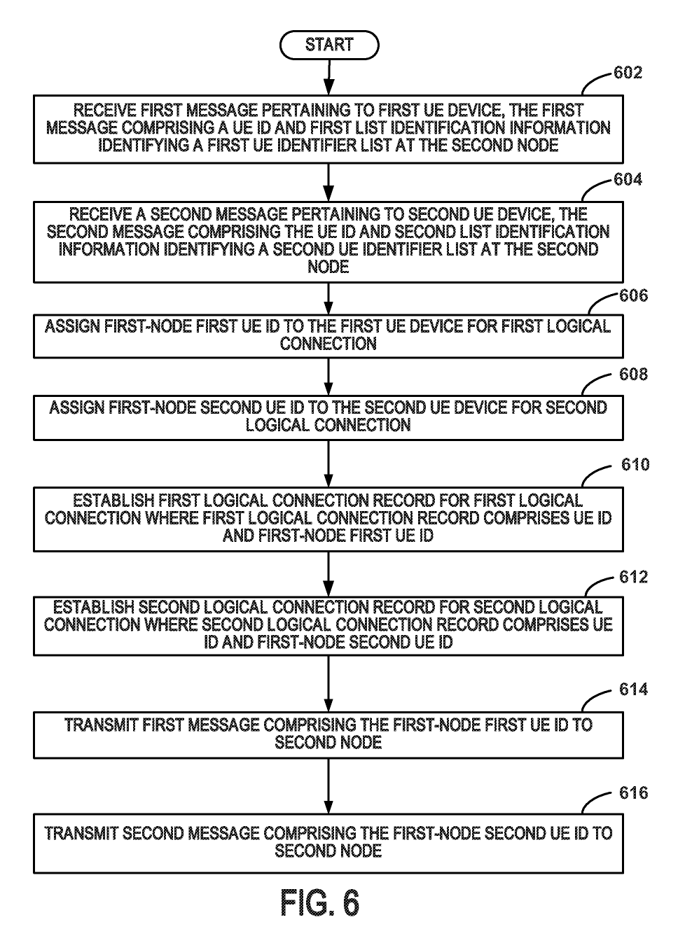

FIG. 6 is a flow chart of an example of a procedure performed at a node for managing UE IDs where the node forms a logical connection with a second node that includes at least two UE ID lists. The steps in the example may be performed in a different order than shown in FIG. 6. Although the example may be performed at any node in a network, an example of suitable node includes the eNB 102 discussed with reference to FIG. 1B.

At step 602, the node receives, from a second node, a message pertaining to a first UE device where the message includes a UE ID and first list identification information identifying a first UE identifier list at the second node.

At step 604, the node receives a message from the second node pertaining to a second UE device where the second received message includes the UE ID and second list identification information identifying a second UE identifier list at the second node. Although the UE IDs are the identical, each UE ID is selected from a different list by the second node and the message identifies the list. As discussed above, the list identification information may be the type of message that is being transmitted or may be a parameter within the message. The UE ID lists are each associated with a function set. Accordingly, the first UE ID list is associated with a first function set and the second UE ID list is associated with a second function set.

At step 606, the node assigns a first-node first UE ID to the first UE device for the first logical connection between the node and the second node for the first UE device. Where the node manages more than one UE ID list, the node also associates first node list identification information to the UE device.

At step 608 the node assigns a first-node second UE ID to the second UE device for the second logical connection between the node and the second node for the second UE device. Where the node manages more than one UE ID list, the node also associates first node second list identification information to the UE device.

At step 610, the node establishes a first logical connection record for the first logical connection where the first logical connection record includes the first-node first UE ID, the UE ID assigned by the second node, and a second node first list identification information. Where the node manages more than one UE ID list, logical connection record also includes first node first list identification information.

At step 614, the node transmits a message to the second node where the message includes the first-node first UE ID. Where the first node manages more than one list, the message also includes first-node list identification information. The message pertains to the first UE device and indicates to the second node the UE ID assigned by the first node to the first UE device. The message also contains the second-node first UE ID and second-node first list identification information assigned by the second node and received at step 602 by the first node.

At step 616, the node transmits a message to the second node where the message includes the first-node second UE ID. Where the first node manages more than one list, the message also includes first-node list identification information. The message pertains to the second UE device and indicates to the second node the UE ID assigned by the first node to the second UE device. The message also contains the UE ID and second-node list identification information assigned by the second node and received at step 604 by the first node.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A method comprising:
assigning, at a first node in a network, a user equipment (UE) identifier to a first UE device for a first logical connection between the first node and a second node, the UE identifier listed in a first UE identifier list and listed in a second UE identifier list;
assigning, at the first node, the UE identifier to a second UE device for a second logical connection between the first node and the second node;
transmitting, to the second node, a first transmitted message pertaining to the first UE device, the first transmitted message comprising the UE identifier and first list identification information identifying the first UE identifier list; and
transmitting, to the second node, a second transmitted message pertaining to the second UE device, the second transmitted message comprising the UE identifier and second list identification information identifying the second UE identifier list.

2. The method of claim 1, wherein the first list identification information is a message type of the first transmitted message and the second list identification information is a message type of the second transmitted message.

3. The method of claim 2, wherein the first UE identifier list is associated with a first function set and second UE identifier list is associated with a second function set, the first UE identifier list comprising at least some UE identifiers that are identical to UE identifiers in the second UE identifier list.

4. The method of claim 3, wherein the first UE identifier list is identical to the second UE identifier list.

5. The method of claim 1, wherein the first list identification information is a first parameter in the first transmitted message and the second list identification information is a second parameter in the second transmitted message.

6. The method of claim 1, further comprising:
receiving, from the second node, a first received message pertaining to the first UE device, the first received message comprising a second-node first UE identifier; and
establishing a first logical connection record for the first logical connection, the first logical connection record comprising the UE identifier and the second-node first UE identifier;
receiving, from the second node, a second received message pertaining to the second UE device, the second received message comprising a second-node second UE identifier; and
establishing a second logical connection record for the second logical connection, the second logical connection record comprising the UE identifier and the second-node second UE identifier.

8. The method of claim 1, wherein the first node is a first enhanced Node B (eNB) and the second node is a second enhanced Node B (eNB).

9. A method comprising:
receiving, at a first node in a network from a second node in the network, a first received message pertaining to a first user equipment (UE) device, the first received message comprising a UE identifier and first list identification information identifying a first UE identifier list at the second node;
receiving, at the first node from the second node, a second received message pertaining to a second UE device, the second received message comprising the UE identifier and second list identification information identifying a second UE identifier list at the second node;
establishing a first logical connection record for a first logical connection between the first node and the second node, the first logical connection for the first UE device, the first logical connection record comprising the UE identifier; and
establishing a second logical connection record for a second logical connection between the first node and the second node, the second logical connection for the second UE device, the second logical connection record comprising the UE identifier.

10. The method of claim 9, further comprising:
assigning, at the first node, a first-node first UE identifier to the first UE device for the first logical connection, the first logical connection record comprising the first-node first UE identifier; and
assigning, at the first node, a first-node second UE identifier to the second UE device for the second logical connection, the second logical connection record comprising the first-node second UE identifier.

11. The method of claim 9, wherein the first list identifier information is a message type of the first message and the second identifier list information is a message type of the second message.

12. The method of claim 11, wherein the first UE identifier list is associated with a first function set and the second UE identifier list is associated with a second function set, the first UE identifier list comprising at least some UE identifiers that are identical to UE identifiers in the second UE identifier list.

13. The method of claim 12, wherein the first UE identifier list is identical to the second UE identifier list.

14. The method of claim 9, wherein the first list identification information is a first parameter in the first received message and the second list identification information is a second parameter in the second received message.

15. The method of claim 9, further comprising:
transmitting, to the second node, a first transmitted message comprising the first-node first UE identifier; and
transmitting, to the second node, a first transmitted message comprising the first-node second UE identifier.

16. The method of claim 15, further comprising:
establishing, at the second node, the first logical connection record for the first logical connection, the first logical connection record comprising the UE identifier and the first-node first UE identifier;
establishing, at the second node, the second logical connection record for the second logical connection, the second logical connection record comprising the UE identifier and the first-node second UE identifier.

17. A node within a network, the node comprising:
a controller configured to assign a user equipment (UE) identifier to a first UE device for a first logical connection between the node and a second node and to assign the UE identifier to a second UE device for a second logical connection between the node and the second node;
a memory configured to store a first UE identifier list comprising the UE identifier and a second UE identifier list comprising the first UE identifier; and
a communication interface configured to:
transmit, to the second node, a first transmitted message pertaining to the first UE device, the first transmitted message comprising the UE identifier and first list identification information identifying the first UE identifier list, and
transmit, to the second node, a second transmitted message pertaining to the second UE device, the second transmitted message comprising the UE identifier and second list identification information identifying the second UE identifier list.

18. The node of claim 17, wherein the first list identification information is a message type of the first transmitted message and the second list identification information is a message type of the second transmitted message.

19. The node of claim 18, wherein the first UE identifier list is associated with a first function set and second UE identifier list is associated with a second function set, the first UE identifier list comprising at least some UE identifiers that are identical to UE identifiers in the second UE identifier list.

20. The node of claim 19, wherein the first UE identifier list is identical to the second UE identifier list.

21. The node of claim 17, wherein the first list identification information is a first parameter in the first transmitted message and the second list identification information is a second parameter in the second transmitted message.
